(19) United States
(12) Patent Application Publication
(10) Pub. No.: US 2010/0116629 A1
(43) Pub. Date: May 13, 2010

(54) Dual action push-type button

(76) Inventors: Milo Borissov, Sharjah (AE); George Spasov, Sofia (BG); Rossi McKee, Sofia (BG)

Correspondence Address: WEIDE & MILLER, LTD., 7251 W. LAKE MEAD BLVD., SUITE 530, LAS VEGAS, NV, 89128, US

(21) Appl. No.: 12/291,828

(22) Filed: Nov. 12, 2008

(51) Int. Cl. H01H 13/02; H01H 13/14

(52) U.S. Cl. 200/4; 200/341

(57) ABSTRACT

A dual action button assembly permits a user to depress a portion of a push button or to rotate the push button to provide input. The dual action button assembly comprises a push button having a plunger which is moveable relative to a housing to actuate a first electrical switch. The push button is rotatably mounted to a button support. Rotation of the push button causes an actuator to actuate a second electrical switch. The dual action button assembly may be custom configured with a push button or be configured as an attachment for use with an existing single-action push button to retro-fit such a button to a dual action button. The dual action button has particular utility to wagering type gaming machines.

### BACKGROUND OF THE INVENTION

1. Field of the Invention

The invention relates to push-buttons and more particularly to such a button which permits different types of inputs.

2. Related Art

Traditional push-buttons are single action input devices. A user pushes a button inwardly to activate a switch. Once released by the user, the button is configured to return to its original position. While push-buttons offer tactile feedback and ease of use, they have a number of drawbacks. Among the drawbacks are that repetitive pressing of a button can become uncomfortable and tiresome, and that such an input action is sometimes not suited to the particular desired input.

### SUMMARY OF THE INVENTION

A dual action button assembly is disclosed. The dual action button assembly permits at least two different types of user inputs. In one embodiment, the dual action button assembly permits a user to provide a push-type input or a rotational or “spin” input in order to activate the button. This allows users to choose how to activate the button and allows gaming or other devices to accept multiple types of activation.

In one embodiment, the dual action button assembly comprises a push button comprising a housing, a plunger and a first electrical switch. The plunger is moveable relative to a housing to actuate a first electrical switch.

Preferably, the push button is rotatably mounted to a push button support. The push button support may comprise a mounting plate. The push button may be mounted to a rotatable mount, such as a bearing race having an inner ring rotatable relative to an out ring. The rotatable mount may be mounted to the push button mount.

A second electrical switch is preferably mounted to the push button mount. An actuator is associated with the push button housing. Rotation of the push button causes the actuator to actuate the second electrical switch.

In one embodiment, at least the plunger of the push button is located above a top of the push button mount, thereby providing convenient access to a user. The electrical switches may be mounted below the push button mount. For example, in a gaming machine environment, a top portion of the push button, including the plunger, may be located above a housing or panel of the gaming machine. The electrical switches and push button mount may be located under the panel or housing, such as within an interior of the gaming machine.

The dual action button assembly may include other features. For example, a grip may be mounted around the push button housing, such as below the plunger, to aid a user in gripping and rotating the push button. Various spacers may be utilized to orient the components of the button assembly.

In one embodiment, a biasing member such as a spring is utilized to bias the push button to a non-activated position. In this manner, when a user rotates the push button, the button returns automatically to its starting position. In a preferred embodiment, tactile feedback is provided to a user when the button is activated by its rotation.

The dual action button has particular utility to wagering type gaming machines. In this configuration, a user of the button may utilize the button to provide different inputs to the gaming machine. For example, a user might provide a “push” input to start the game, and provide a rotational input to make game play selections.

One aspect of the invention is a dual action attachment. The attachment includes a push button mount, switch and actuator. An existing single-action push-button may be retrofit to dual action by rotatably mounting it to the push button mount. The actuator is connected to the push button so that it actuates the switch.

Other apparatus, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a top perspective view of an exemplary embodiment of the invention.

FIG. 2A is a top perspective view of an exemplary embodiment of the invention.

FIG. 2B is a bottom perspective view of an exemplary embodiment of the invention.

FIG. 3 is an exploded view of an exemplary embodiment of the invention.

FIGS. 4A-4F are top and bottom perspective views of exemplary embodiments of the invention in use.

FIG. 5 is a perspective view of an exemplary embodiment of the invention installed in a device.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One aspect of the invention is a user input device configured to accept multiple types of input. In one embodiment, the input device is a dual-action button which may be activated by a pressing or pushing input, or by a spinning or rotational input, or both. In one embodiment, input to the button activates one or more switches associated with the button. As will be described further below, the switches may be electrical contact switches which may be activated by completing or breaking an electrical connection therein.

Various advantages are realized by the dual action button. The button may be activated by either spinning or by pushing, allowing a user to choose how they wish to activate the button. For instance, a user may prefer spinning the button rather than pushing the button, or vice versa, because it is more comfortable for the user. The button may also be used to provide different inputs or control different functions, depending on how it is activated. For instance, spinning the button may control one function while pushing the button controls another function.

The dual action button is particularly suited for use with gaming or wagering devices. As will be described further below, the button may be installed as an assembly in a gaming machine. An existing single-action button may also be retrofit with an attachment or assembly to convert it to a dual action button. In either event, players may then have the option of either pushing or spinning the button to provide game input. This is advantageous in that players have the option of spinning buttons, which may be more convenient, ergonomic, or comfortable than pushing, or vice versa. The button is also advantageous in that spinning may correspond to one function of or input to a gaming machine, while pushing may correspond to another function. For example, a player may spin the button to effectuate spinning of the gaming machine's reels, while pushing the button may effectuate another function. This makes the gaming machine more intuitive for players as well. It is noted that the button is versatile in that a dual action button, such as one which spins and pushes, may also be used to perform the same function, such as for example spinning the machine's reels.

In one or more embodiments, the dual action button may be installed or used with various electronic devices including, but not limited to, gaming machines, kiosks, computers, hand held devices, or portable devices. In fact, the button may be used with any device which utilizes one or more buttons. In addition, as will be described below, a dual action button attachment may be provided to allow traditional push buttons to be retrofitted so they may be spin activated.

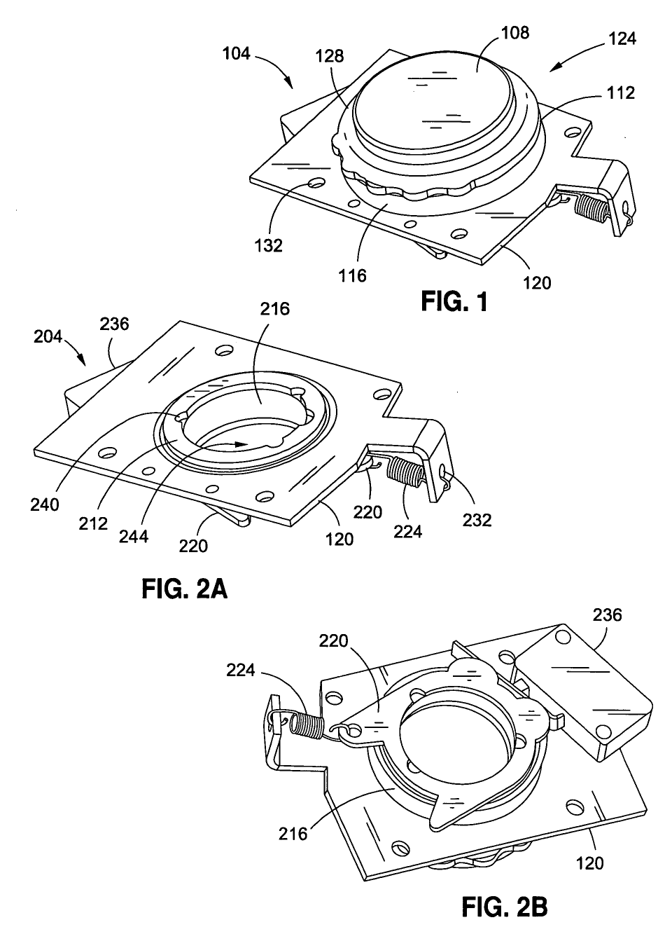

Various embodiments of the invention will now be described with reference to the figures. FIG. 1 is a perspective view of an exemplary dual action button assembly 104. As detailed below, in the embodiment illustrated, the “dual” action of the button permits a user to effect input by two different inputs or motions, preferably a pushing or pressing input or a rotational or “spin” input.

In one embodiment, the push button assembly 104 comprises a push button 124 configured to actuate a switch, the push button rotatably mounted to a push button support 120, whereby rotation of the push button is configured to actuate a switch. As shown, the push button 124 has a housing 128 which generally provides a structure to support various components of a push button, including a plunger 108. As detailed below, the plunger 108 is movable relative to the housing 128. Preferably, the plunger 108 is “depressable”, in that it is movable in response to a pressing or pushing input by a user. When so actuated or activated, the plunger 108 activates a switch or other signal generating element, as also detailed below.

As described further below, the push button 124 is also configured for rotational actuation or activation. In one embodiment, the button 124 is mounted for rotation, wherein rotation of the button 124 activates a switch or other signal generating element. In one embodiment, the button 124 is mounted to a push button support 120.

Though the exterior of the push button 124, including the housing 128, is illustrated as round, it is contemplated that buttons of varying types, shapes, and sizes may be used with the invention. For example, square, rectangular, or other shaped buttons may be used. In addition, other types of controls may be used. For example, a switch or knob may be rotatably mounted to the push button support 120 according to the invention herein.

In one or more embodiments, the push button support 120 serves as a structure to which other components of the dual action button assembly 104 may be mounted or attached. For example, the push button support 120 may be a planar rigid structure having an opening to accept a component of the assembly 104. In addition, the push button support 120 may used to attach the assembly 104 to a gaming machine or other device. For example, the push button support 120 may include one or more holes 132 for accepting mechanical fasteners for attachment to a gaming machine or other device.

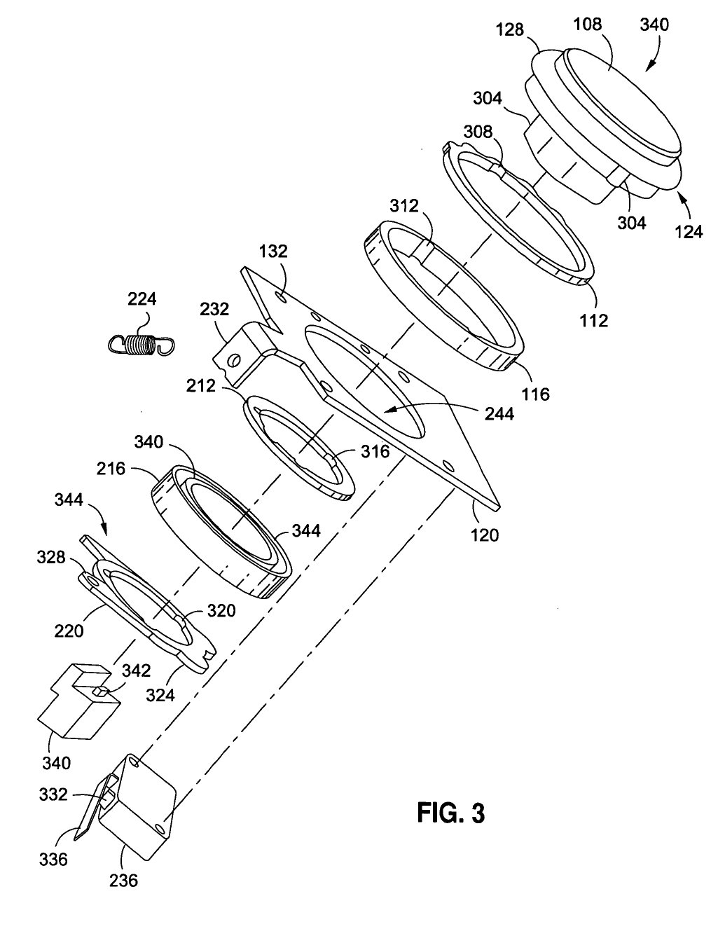

In one embodiment, the dual action button assembly 104 includes a grip in the form of a grip 112, the grip configured to be engaged by a user for spinning the push button 124. The grip 112 may be configured to surround the perimeter of at least a portion of the push button 140, and may thus be annular or “ring” shaped, as best illustrated in FIG. 3. For example, the grip 112 may surround at least a portion of the push button's 124 housing 128. The grip 112 may have an exterior shape which is round, oval, rectangular, square, or other shapes. Preferably, the grip 112 is similar in exterior shape to the adjacent push button 124, but defining one or more portions extending outwardly of the push button for engagement by a user.

In one embodiment, as shown in FIG. 3, the push button 124 and the grip 112 may be associated or locked together in mating relationship. As illustrated, the grip 112 has a notch 308 which accepts a tab 304 extending from the housing 128 portion of the push button 124. In this manner, the push button 124 and the grip 112 may spin together. Of course, the grip 112 might be mounted to the push button 124 in other manners, including by adhesive, fasteners or other connectors. In addition, the push button 124 or a portion thereof may be shaped to allow other components to be associated or locked thereto. For example, a portion of the push button's 124 housing 128 (or other portion of the push button) may be a square, hexagonal, or other shape. Other components of the dual action button assembly 104 may then having correspondingly shaped openings. The angles of these shapes lock the components to the push button 124 so they may spin or rotate with the push button.

It is noted that the grip 112 may not be required in all embodiments because the push button 124 may be directly engaged and spun by a user. In addition, it is contemplated that the push button 124 may include one or more ridges, such as on its housing 128, to aid a user in gripping or gasping the push button and spinning it.

A spacer 116 may be included in some embodiments to raise the grip 112 and push button 124 above the push button support 120 so that the push button and grip may be more easily spun or pushed. A spacer 116 is optional, however. The spacer 116 may be round, oval, rectangular, square, or other shapes, but preferably is similar in exterior shape to the adjacent push button 124. For example, in the embodiment of FIG. 1, the spacer 116 has a circular shape similar to the perimeter shape of the push button 124. In one or more embodiments, the spacer 116 may be configured such that it does not extend past the grip 112 or the ridges on the grip. This allows the grip 112 to be more easily gripped because the spacer 116 does not interfere with or prevent the grip or its ridges from being engaged by a user.

As shown in FIG. 3, the spacer 116 in some embodiments may include a notch 312 configured to accept a tab 304 on the push button 124. In this manner, the spacer 116 may rotate along with the push button 124. Alternatively, if desired, a tab may be provided on the push button support 120 to secure the spacer 116 in a stationary position relative to the spinning components of the dual action button assembly 104, such as the push button 124 and grip 112.

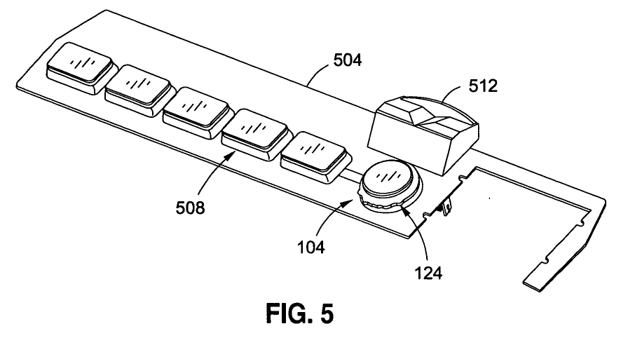

In one embodiment, the plunger 108 and grip 112 comprise the user-engageable portions of the dual action button assembly 104. In particular, as detailed below and illustrated in FIG. 5, the button assembly 104 may be mounted so that these elements are located above a housing or deck of a gaming machine or the like. However, the dual action button assembly 104 preferably includes other elements. These elements may be located below such a mounting and may not be user accessible.

FIG. 2A is a top perspective view of an exemplary dual action button assembly 104 with the push button, grip, and spacer removed to better show other elements of the invention. FIG. 2A illustrates the push button support 120, as well as a rotatable mount 216 and a mount spacer 212 associated therewith.

In one embodiment, the push button support 120 defines an opening 244. Typically, the opening 244 will be a similar shape and size as the outside perimeter of the rotatable mount 216 to allow the rotatable mount to be inserted and mounted in the opening. The rotatable mount 216 is preferably annular, itself defining an opening for receiving the push button 124. In this manner, as will be described further below, the rotatable mount 216 allows the push button 124 to rotate or spin. As shown, the rotatable mount 216 may comprise a bearing race or ring having an exterior portion attached to the push button support 120 and an interior portion which is allowed to rotate or spin. This may also be seen in FIG. 3, which illustrates a rotatable mount 216 having independently rotatable inner and outer rings 340,344. In one embodiment, the outer ring 344 is attached to the push button support 120 within the opening 244 while the inner ring 340 remains freely rotatable.

The mount spacer 212 may be located on or attached to the inner ring 340 while the outer ring 344 is attached to the push button support 120. In this manner, the inner ring 340 and attached mount spacer 212 may freely rotate relative to the push button support 120. The spacer 116, grip 112, push button 124, or a combination thereof may be attached or locked to the mount spacer 212 and rotate along with the mount spacer 212. It is noted that, as described above, the spacer 116 and grip 112 are optional and may not be included in all embodiments.

The mount spacer 212 may include one or more notches 316 as well. Each notch 316 may be configured to accept a tab 315 of the push button 124 to lock the mount spacer 212 to the push button 124. In this manner the mount spacer 212 may rotate along with the push button 124 such as described above with regard to the grip and spacer. It is contemplated that a mount spacer 212 may not be required in all embodiments because components of the upper portion of the dual action button assembly 104 may be directly attached to the rotatable mount 216 or a portion thereof. The advantage of including the mount spacer 212, in one or more embodiments, is that the mount spacer 212 may be configured to provide a surface elevated above the push button support 120, rotatable mount 216, or both to more easily attach the upper portion of the dual action button assembly 104.

FIGS. 2A and 2B illustrate a switch 236 and actuator 220 of one embodiment of the dual action button assembly 104. In one embodiment, the switch 236 and actuator 220 are located below the push button support 120. In one or more embodiments, the actuator 220 is configured to actuate the switch 236 when the push button 124 is activated. As can be seen from FIGS. 2B and 3, the actuator 220 may be shaped to actuate the switch 236 such as by including one or more protrusions 324 which may contact the switch when the actuator is rotated. In one embodiment, the actuator 220 is mounted to the push button 124 so that activation of the push button causes the actuator 220 to rotate and actuate the switch 236. While the actuator 220 may comprise a separate element which is mounted to the push button 124, it might also comprise an extension or protrusion there from. Alternatively, the actuator 220 might comprise more than one element, such as a protrusion on the push button 124 which causes another element to move, that element actuating the switch 236. Operation of the actuator 220 and switch 236 will be described further below.

As indicated, the push button 124 may be actuated, thus causing the push button spacer 124 to move from a first non-activated position (in which it does not activate the switch 236) to a second, activated position (in which it does activate the switch 236). In one embodiment, the dual action button assembly 104 includes a means for returning the actuator 220 from its second position back to its first position. In one embodiment, that means comprises at least one biasing member, such as a spring 224. For example, the spring 224 may comprise a coil spring which is attached to the actuator 220 to provide resistance to the actuator's rotation and to return the actuator after it has been rotated. One end of the spring 224 may be attached to the actuator 220 and the other end thereof may be mounted to a spring mount 232 extending from the push button support 120. Of course, the spring 224 may be attached to any fixed point relative to the actuator 220 if desired. For example, the spring 224 may be attached to another portion of the push button support 120 or to a portion of a gaming machine or other device.

The mount spacer 212 may be located on or be attached to the top of the inner ring 340 of the rotatable mount 216, while the actuator 220 is located under or mounted to the bottom of the inner ring 340. It can thus be seen that any spinning or rotation of the inner ring 340 causes both the mount spacer 212 (and any components attached thereto) as well as the actuator 220, to rotate or spin. As described above, rotation of the inner ring 340 may be caused by a user during spin activation of the invention, or by the spring 224 returning the actuator 220 to its original position or resting position after it has been rotated.

The actuator 220 may include one or more notches 320 configured to accept a tab 304 of the push button 124 in some embodiments. In this manner, the actuator 220 may be locked to the push button 124, and vice versa, and thus the actuator and push button (as well as other spinable components) may rotate together.

FIG. 3 provides a more complete view of the switch 236. In one or more embodiments, the switch 236 is an electrical switch which includes a contact 332 which completes or breaks an electrical circuit within the switch when actuated. The completion or breaking of the electrical circuit may be detected by a gaming machine or other device, and indicate to the gaming machine or other device that the dual action button assembly 104 has been activated. In the embodiment shown in FIG. 3, the switch 236 includes an actuation plate 336 in front of the contact 332 which provides a larger surface for the actuator 220 to contact. The actuation plate 336 is advantageous in that the actuator 220 does not have to precisely or directly engage the contact 332 to actuate the switch 236 because it may engage the actuation plate 336 instead.

In one embodiment, a user's activation of the plunger 108 is also configured to provide input. In one embodiment, this input is to another switch 340. The switch 340 may be mounted to the housing 128 of the push button 124. The switch 340 may include a contact 342 which is moved or contacted by the plunger 108 or an element moved by the plunger. The push button 124 may have various configurations for actuating such a switch, and the configuration of the switch and its mounting may vary. One example of a configuration of a push-button switch is illustrated in U.S. Pat. No. 6,590,176, which is incorporated herein by reference. In other configurations, it is possible for the plunger 108 to effect input to the same switch 236 which is actuated as a result of a user providing a spinning or rotating input.

In the case where there are two switches 236,340, push activation and spin activation complete or break separate electrical circuits to allow a gaming machine or other device to detect two different inputs. It is also contemplated that push activation may emit a first signal while spin activation emits a second signal to a gaming machine or other device. Alternatively, push activation and spin activation may complete or break a single electrical circuit, or emit the same signal, in some embodiments. In this case, the type of activation may not be determinable and push and spin activation may perform the same function on a gaming machine or other device.

FIG. 3 provides additional detail of the embodiment dual action button assembly 104. As shown, the assembly has a top end 340 and a bottom end 344. The rotatable mount 216 may mounted within an opening 244 of the push button support 120. The opening 244 will typically (but not always) conform to the shape of the perimeter of the rotatable mount 216. This allows the rotatable mount 216 to be held within the opening of the push button support 120 by a friction fit. Of course, one or more welds, mechanical fasteners, adhesive, or a combination thereof may be used to hold the rotatable mount 216 in addition to or instead of the friction fit.

In one embodiment, the housing 128 of the push button 124 is configured to mount various elements. As illustrated, the housing 128 has a top or proximal portion and a bottom or distal portion. The plunger 108 is preferably located at the top portion for access by a user. The distal portion preferably defines a mounting area. As indicated, the grip 112 and spacer 116 are preferably mounted to that portion of the housing 128, as are the spacer 212, bearing ring 216 and actuator 220. As indicated, these components may be mounted to the housing 128 via interlocking tabs and notches or other mounting configurations, preferably such that the push button 124, grip 112, spacer 116, mount spacer 212, and actuator 216 rotate together.

It is contemplated that, in the above embodiment, at least some of the components of the dual action button assembly may be assembled without fastening, adhering, or otherwise attaching them together. In one or more embodiments, the mount spacer 212, spacer 116, and grip 112 may be located on top of the rotatable mount 216, such as shown in FIG. 3. The actuator 220 may be located beneath the rotatable mount 216. A portion of the push button 124 such as its housing 128 may then inserted through grip 112, spacer 116, mount spacer 212, rotatable mount 216, and actuator 220. One or more tabs 304 on the push button 124 may be used to lock the grip 112, spacer 116, rotatable mount 216, and actuator 220 together. The actuator 220 may then be attached to a portion of the housing 128 to prevent the components above the actuator from sliding off the housing. The actuator 220 may be removably or permanently attached to the housing 128 in one or more embodiments. It is contemplated that the assembly may be assembled in the above described manner even where one or more optional components (as described herein) are omitted.

In other embodiments, the components may be attached rather than locked together. For example, the grip 112, spacer 116, mount spacer 212, rotatable mount 216, and actuator 220 may be attached together such as with adhesives, welds, one or more mechanical fasteners, or a combination thereof. In addition, one or more of the components may be integrally formed (i.e. formed in one piece). For example, the actuator 220 and mount spacer 212 may be integrally formed into the inner ring 340 of the rotatable mount 216. In addition, the spacer 116 and grip 112 may be integrally formed. As stated above, embodiments where the components are attached together may not utilize notches or tabs to allow the components to rotate together.

As one aspect of the invention, a kit may be utilized to retro-fit an existing single-action push button into a dual action button. FIG. 2A illustrates a dual action button attachment 204. In general, the components of the attachment 204 perform the same function as described above with regard to the assembly. Thus, the configurations and operations of components described with regard to the assembly may also apply to the attachment 204.

In contrast to the assembly 104 however, the attachment 204 may be provided to retrofit existing push buttons so that they may be spin activated. For example, an existing push button from a gaming machine may be removed and reinstalled within the attachment 204 to allow the push button to be spin activated. It is noted that a spacer 116, grip 112, or both may be provided in some embodiments. As one example, the push-button of U.S. Pat. No. 6,590,176 might be mounted to the assembly 104. For example, referring to the '176 Patent, the lock nut (30) may be removed and the push-button thereof inserted into the rotatable mount 216, thereby associating the push-button with the attachment 204, and permitting the single-action push-button of the '176 Patent to have the dual action feature of the present invention.

The attachment 204 may be configured to accept any manufacturer's push button. For example, commonly used push buttons on gaming machines may be installed within the attachment 204 to allow for spin activation of the buttons. As shown in FIG. 2A, the attachment 204 includes a switch 236 actuated by an actuator 220 which rotates via the rotatable mount 216. A mount spacer 212 may be location at a top of the rotatable mount 216 to allow a push button to be installed or mounted to the attachment 204.

The mount spacer 212 of the dual action button attachment 204 may include one or more notches 240 to accept tabs of a push button. In this manner, a push button may be locked to the mount spacer 212 allowing the attached actuator 220 to rotate with the push button. It is contemplated that the notches 240 may be configured to conform to the tabs of various types, brands, or configurations of push buttons.

Though shown in a round configuration, it is contemplated that the attachment 204 may be configured to accept various shaped buttons including but not limited to square, rectangular, or other shaped buttons. In one or more embodiments, this may be accomplished by providing a spacer 212 capable of accepting the desired shaped button.

As indicated, the push buttons used with the attachment 204 or assembly 104 may include one or more of their own switches. In these embodiments, pushing the push button may actuate the push button's own switch. This is advantageous in that the attachment 204 may be configured to indicate whether the spin activation, push activation, or both are occurring and perform a different function in response to either or both. For example, spin activation may complete or break a different circuit, or emit a different signal to a gaming machine or other device than push activation. The attachment 204 may also be configured to only indicate that it is being activated regardless of whether the activation is occurring by spinning or pushing the push button. For example, spin or push activation may complete or break a single circuit or may emit the same signal.

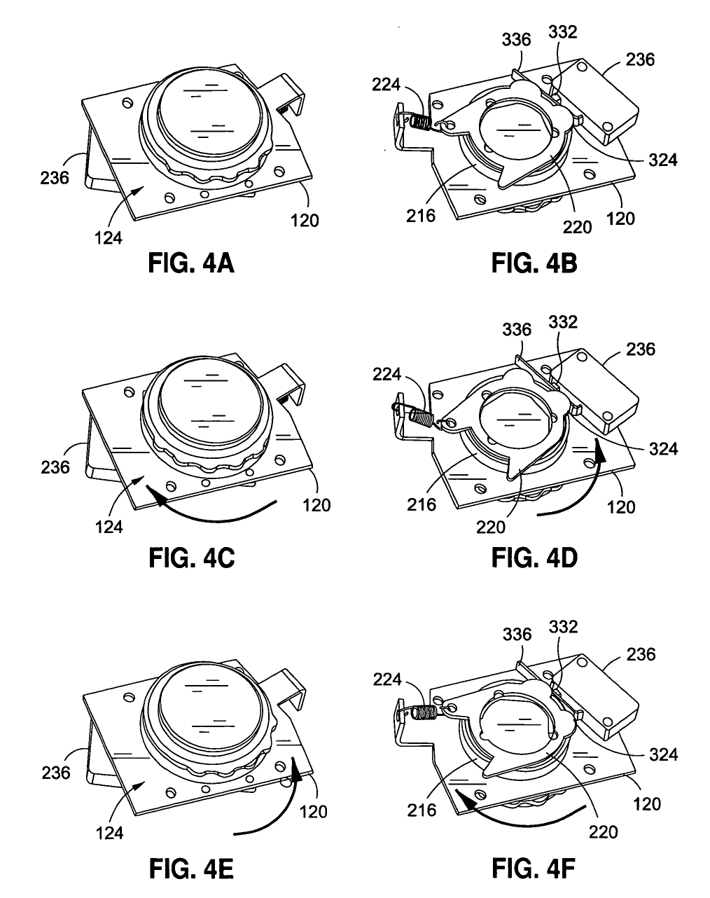

Operation of the dual action button assembly will now be described with regard to FIGS. 4A-4F. It will be understood that, in one or more embodiments, the dual action button attachment will operate in like manner.

FIG. 4A is a top perspective view of an exemplary embodiment of the dual action button assembly 104 in a non-activated or resting position. FIG. 4B is a bottom perspective view of the same assembly. In the resting position shown, the actuator 220 is at an angle where there may be little or no tension on the spring 224. The actuator 220 may or may not be in contact (i.e. touching) the switch 236, actuation plate 336, contact 332, or a combination thereof. Generally, the switch 236 will not be actuated by the actuator 220 when the assembly 104 is in a resting position. However, it is noted that in some embodiments, the assembly 104 may be configured such that the switch 236 may be actuated when in a resting position, and unactuated when in a pressed position.

FIGS. 4C and 4D respectively illustrate a top and bottom perspective view of an exemplary embodiment of the dual action button assembly 104 in a clockwise activated position. FIG. 4C illustrates a push button 124 being spun in a clockwise direction as shown by the arrow therein. FIG. 4D illustrates the corresponding rotation of the actuator 220 (and other components) when the push button 124 is spun in a clockwise direction. The direction of this rotation is also indicated by an arrow in FIG. 4D.

As stated, the actuator 220 (as well as other components) may be associated or locked to the push button 124 such that they spin together. Thus, the clockwise spin of the push button 124 causes a corresponding rotation of the locked components including the actuator 220. As shown in FIG. 4D, the actuator 220 rotates such that it engages and actuates the switch's 236 contact 332 through the actuation plate 336. It is contemplated that the actuation plate 336 may be comprised of rigid but resiliently flexible material in one or more embodiments. This allows the actuation plate 336 to be moved by the actuator 220 to actuate the contact 332 of the switch 236. In the embodiment shown, the actuator 220 may include one or more protrusions 324 shaped to actuate the switch 236 when the spacer 220 is rotated. In one embodiment, the protrusions 324 are somewhat round. The protrusion 324 provides tactile feedback to the user when rotating the push button 124. In particular, the user can “feel” the push button 124 reaching the activation mode because of the initial resistance of movement (as the steep face of the protrusion 324 moves along the actuation plate 336) and then decrease in resistance (as the flatter top of the protrusion moves along the actuation plate 336).

When the actuator 220 is rotated, the spring 224 provides resistance which is transferred through the push button 124 to giving the user tactile feedback. As can be seen from FIG. 4D, the spring 224 is stretched as the push button 124 is spun. Once the push button 124 is released, the biasing force generated by the spring 224 returns the push button 124, actuator 220, and other components back to the resting position.

Feedback is also given to a user when spin activation has been accomplished. For example, the user may feel, through the push button 124, when the contact 332 of the switch 236 has actuated. In addition, actuation of the switch 236 may produce a sound such as a click to provide feedback to a user. Also, the push or spin activated button assembly 104 may be configured such that the push button 124 may not be allowed to spin any further once the switch 236 has been actuated. In this manner the user knows that spin activation has occurred because the push button 124 can be spun no further. Providing feedback, such as described herein, is advantageous in that it allows a user to feel, hear, or otherwise know that they have activated the dual action button assembly 104 successfully. Without feedback, the user may be confused as to whether or not the spin activation has occurred.

It is contemplated that in some embodiments the dual action button assembly 104 may be configured to allow the push button 124 and associated components to spin without restriction. For example, the actuator 220 may be configured to actuate a switch 236 when the actuator is rotated to or through a certain point. The assembly 104 may be configured to allow clockwise spinning, counterclockwise spinning, or both. In these embodiments, a spring 224 will generally not be necessary. Feedback may be provided by feeling the actuation of the switch 236 through the push button 124, by a sound such as a click, or both.

FIGS. 4E and 4F respectively illustrate a top and bottom perspective view of an exemplary embodiment of the dual action button assembly 104 in a counterclockwise activated position. FIG. 4E illustrates a push button 124 being spun in a counterclockwise direction as shown by the arrow therein. FIG. 4F illustrates the corresponding rotation of the actuator 220 (and other components) when the push button 124 is spun in a clockwise direction. The direction of this rotation is also indicated by an arrow in FIG. 4F.

As can be seen from FIG. 4F, the counterclockwise spin of the push button 124 rotates the actuator 220 in a different direction than shown in FIG. 4D. A different portion or protrusion 324 of the actuator 220 engages and actuates the switch's 236 contact 332 through an actuation plate 336 during counterclockwise spin activation. It is noted that the dual action button assembly 104 may be configured such that the same portion or protrusion 324 of the actuator 220 engages and actuates the switch's 236 contact 332, in one or more embodiments.

In the embodiment illustrated, the spring 224 is connected to the actuator 220 at an arm or extension thereof whereby the spring 224 tends to bias the spacer 220 back to a nonactivated position no matter which direction it is rotated. In other embodiments, two or more springs might be used to bias the actuator 220 back to such a position.

Similar to above, the spring 224 is stretched by the rotation of the actuator 220 and provides resistance and feedback to the user through the push button 124. Upon release of the push button 124, the spring 224 may return the push button and other components to the resting position. Feedback may be provided to users as described above with regard to clockwise spin activation. In addition, the dual action button assembly 104 may be configured to allow the push button and associated components to spin freely, or to prevent spinning past a certain point. Typically, the assembly 104 will be configured to prevent spinning once the switch 236 as been actuated.

In one embodiment, the dual action button assembly 104 may be configured to detect the direction of spin. For example, the switch 236 may have multiple contacts 332, or there may be multiple switches 236, corresponding to each direction of spin. One or more contacts 332 or switches 236 may be actuated when the push button 124 is spun in one direction, while one or more other contacts or switches may be actuated when the push button is spun in another direction. In this manner the direction of spin may be determined based on which of the contacts 332 or switches 236 have been actuated.

The push button 124 may be push activated before, during, or after spin activation such as by a user pressing the push button's plunger. Thus, it is noted that a user may also be push activating the dual action button assembly 104 before, after, or while spinning the push button 124. It is contemplated that the invention 104 may indicate to a gaming machine or other device that push and spin activation is occurring at the same time in one or more embodiments. This allows the assembly 104 to collect various types and combinations of user input (i.e. spinning, pushing, or both).

It is specifically contemplated that the dual action button assembly or the dual action button attachment may be used with a gaming machine. Such a machine may include a housing or cabinet which supports and/or houses various components. These components may include one or more display devices such as electronic displays, spinning reels or the like configured to present game information. The gaming device may be configured to present games to a player for wager, and offer the opportunity for winnings. Such devices are well known and come in a variety of configurations and are configured to offer a variety of games. Existing machines may include one or more standard push-buttons for accepting game play input from a player.

FIG. 5 illustrates the dual action button assembly 104 installed in a button panel 504 of a gaming machine having a coin slot 512 configured to accept wagers. As stated above, the dual action button attachment 204 may be similarly installed to retrofit an existing button of a gaming machine such that it may be spin activated.

The assembly or attachment may be secured or otherwise attached to a gaming machine by one or more fasteners or adhesives. For example, referring to FIG. 1, fasteners may be inserted into the holes 132 of the push button support 120 to attach the assembly or attachment to a gaming machine. In one or more embodiments, the holes 132 may be configured or positioned to correspond to existing screw holes on a gaming machine to allow for easy installation.

The dual action button assembly 104 may be installed next to traditional buttons 508 or may replace the traditional buttons (or retrofit them). In the embodiment of FIG. 5, the assembly 104 is provided where a button labeled “spin” would typically be positioned. In this embodiment, the push button 124 of the assembly 104 may be spin activated to spin the reels of a gaming machine. In addition, the push button 124 may also be push activated to spin the reels of a gaming machine. Alternatively, push activation may be used to “bet one” while spin activation is used to spin the reels.

As stated, spin activation may correspond to one or more functions of a gaming machine, while push activation may correspond to one or more other functions of a gaming machine. In other embodiments, both push and spin activation correspond to the same one or more functions of a gaming machine. In this case, the assembly or attachment provides the advantage of allowing users to select how they wish to interact with the gaming machine, based on personal preferences, comfort, or other factors. In such a configuration, actuation of either switch 236,340 might provide the same input to the gaming machine or other device. In other embodiments, push activation and spin activation might actuate the same switch. For example, it is possible for the dual action button assembly to include only a single switch, wherein both actuation of the plunger and rotational input actuate the same switch. In one embodiment, actuation of the plunger might even be configured to effect rotation of the switch in similar manner to direct rotation.

In other embodiments, however, the different activations or actuations preferably provide separate and different inputs to a gaming machine or other device. For example, in a slot machine embodiment, spin activation may also be associated with the selection of paylines such as by scrolling through each selectable payline or paylines by spinning the push button (via actuation of the first switch 236). Push activation may then be used to indicate that the user's desired payline or paylines have been selected (via actuation of the second switch 340). Spin activation may then also be used to spin the reels of a slot machine. It can thus be appreciated that spin activation may be associated with functions analogous to spinning such as spinning reels, scrolling, increasing or decreasing bets, or selecting paylines, items, options, and the like by advancing or moving through them one-by-one. This allows gaming machines to be more intuitive and easier to use, and the invention provides these benefits while being capable of push activation.

The push or spin activated button assembly and attachment as well as their benefits may be used with other devices as well. For example, the invention may be used with ATMS, kiosks, computers, and other electronic devices. In addition, the invention may be used with portable devices. As with above, spin activation may be associated with functions analogous to spinning, or may be used as an alternative to push activation (i.e. spin activation may perform the same function as push activation).

Specifically with regard to the push or spin activated button attachment, gaming machines and other devices may be easily retrofitted so that their existing push buttons may be spin activated as well as push activated. This provides users with the ability to select between spin or push activation, and allows gaming establishments, manufacturers, end-users or others to retrofit gaming machines or other devices to accept both spin and push activation.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A dual action button assembly comprising:
a push button support having a top and a bottom and defining an opening there through;
a first switch supported by said push button support;
a rotatable mount mounted within said opening of said push button support;
a push button mounted to said rotatable mount, said push button comprising:
a housing;
a plunger; and
a second switch supported by said housing and configured to be actuated by said plunger;
wherein at least said plunger of said push button is located above said top of said push button support;
an actuator mounted to said housing of said push button and located below said push button support, said actuator configured to actuate said second switch when said actuator is rotated;
a spring attached to said actuator and said push button support, said spring configured to provide resistance to the rotation of said actuator and to return said actuator to a resting position;
a grip located exterior to said housing of said push button and located above said push button support;
wherein said button is push activated by actuating said plunger to activate said second switch and spin activated by rotating said push button to actuate said first switch.

2. The assembly of claim 1 wherein said push button support comprises a mounting plate.

3. The assembly of claim 1 wherein actuator comprises a ring mounted to said housing, said actuator having one or more protrusions extending there from.

4. The assembly of claim 1 wherein rotation of said actuator is blocked by said switch after said actuator is rotated to an activated position.

5. The assembly of claim 1 wherein said grip comprises a ring mounted on said housing of said push button.

6. The assembly of claim 1 wherein said first switch further comprises an actuation plate located between said contact of said first switch and said actuator, said actuation plate configured to allow said actuator to actuate said contact.

7. A dual action button attachment comprising:
a push button support;
a switch attached to said push button support, said switch having at least one contact;
a rotatable mount having a first portion connected to said push button support and a second portion rotatable relative to said first portion, said second portion having an opening therein for accepting a portion of a push-button therein; and
an actuator for connection to said push-button whereby rotation of said push-button is configured to cause said actuator to engage said switch and activate said contact.

8. The button attachment of claim 7, wherein said rotatable mount comprises a bearing ring.

9. The button attachment of claim 7 further comprising a spring attached to said actuator and said push button support, said spring configured to provide resistance to the rotation of said actuator.

10. The attachment of claim 7 wherein said switch further comprises an actuation plate located between said contact of said switch and said actuator, said actuation plate configured to allow said actuator to actuate said contact.

11. A dual action button comprising:
a push button, said push button comprising:
a housing;
a depressable plunger moveable relative to said housing; and
a first electrical switch, said first switch operable by said plunger;
a push button support, said push button rotatably mounted to said push button support; and
a second electrical switch, said second switch operable by rotating said push button relative to said push button support.

12. The button of claim 11 wherein said push button is rotatably mounted to said push button support with a rotatable mount having an inner ring rotatable relative to an outer ring.

13. The button of claim 12 wherein said outer ring is mounted to said push button support and said housing of said push button is mounted to said inner ring.

14. The button of claim 11 further comprising an actuator connected to said housing of said push button, said actuator configured to operate said second electrical switch when said push button is rotated relative to said push button support.

15. The button of claim 11 further comprising a grip mounted to said housing of said push button, said grip located above a top of said push button mount.
